(19) United States
(12) Patent Application Publication
(10) Pub. No.: US 2019/0171638 A1
(43) Pub. Date: Jun. 6, 2019

(54) MULTI-LINKED WORKFLOWS

(71) Applicant: ONBASE DB SYSTEMS INC., Vancouver (CA)

(72) Inventors: Kevin RUTTEN, Surrey (CA); Harold DAVIDSON, Surrey (CA); Terrance GRAY, Vancouver (CA)

(73) Assignee: ONBASE DB SYSTEMS INC., Vancouver, BC (CA)

(21) Appl. No.: 16/321,380

(22) PCT Filed: Jul. 28, 2017
(86) PCT No.: PCT/CA2017/050902

§ 371 Date: Jan. 28, 2019

Related U.S. Application Data
(60) Provisional application No. 62/368,948, filed on Jul. 29, 2016.

(51) Int. Cl. G06F 16/2453; G06F 16/248; G06F 16/242; G06F 3/14

(52) U.S. Cl. CPC G06F 16/2453; G06F 3/1454; G06F 16/242; G06F 16/248

(57) ABSTRACT

The present disclosure relates to systems and methods for users to work efficiently with data, including big data and data having rich or complex relationships.

### CROSS REFERENCE TO RELATED APPLICATIONS

This application claims priority from United States provisional patent application serial number U.S. 62/368,948 filed on Jul. 29, 2016 entitled MULTI-LINKED WORKFLOWS, which is expressly incorporated herein, to the fullest extent permitted by law.

### BACKGROUND

### 1. Field

The present disclosure relates to systems and methods for users to work efficiently with data, including big data and data having rich or complex relationships. The invention may be deployed in various configurations, including client-server and standalone configurations.

### 2. Description of Related Art

As the volume, velocity and variety of data continues to increase, data workers (users) need tools and other technical solutions to work with such data, let alone work efficiently and effectively (and hence productively).

In one example of this challenge, particular users require that data appropriate for their particular needs be delivered in a timely manner and presented in a useful format.

Another broader challenge is that the quality of the data itself can become degraded should a system be too frustrating or onerous for its users, such that they don't embrace—or even game—data collection processes, seeing it as a burden unwarranted by the intelligence it yields.

Accordingly, what is needed is a better way to address challenges in managing data, for example enterprise data. Aspects and advantages of the present invention will become apparent upon considering the following drawings and description.

### SUMMARY

The present disclosure is directed to this need.

According to one aspect of the present disclosure, there is provided an electronic device having a processor, a storage medium and a client component stored on the storage medium, the client component having machine-executable code for execution by the processor for managing data, wherein managing data includes:

a. instantiating a workflow,

b. instantiating a workspace associated with the workflow,

c. instantiating at least two screens associated with the workspace,

d. instantiating at least one presentation space associated with each of the at least two screens, and

e. presenting a respective at least one data fragment in each respective at least one presentation space,

wherein:

the at least one data fragment is operable to be currently selected when presented in the respective at least one presentation space, and

in response to said selection, at least one other of the at least one presentation space presenting a corresponding data fragment.

The at least one presentation space may have a constraint bar, having at least one of: a search box, a filter box and a sort box, for constraining the data fragments presented, respectively by search, filter and sort.

The at least one presentation space may be operable to have focus, and in response to the at least one presentation space having focus, at least one other of the at least one presentation space may present a constrained data fragment constrained by the constraint bar of the at least one presentation space.

The at least one presentation space may have at least one of: a table space, a detail space, and a mash-up space.

The at least two screens may respectively have tabs for selecting between presentation spaces.

According to another aspect of the present disclosure, there is provided a computer-implemented method for managing data, comprising:

a. instantiating a workflow,

b. instantiating a workspace associated with the workflow,

c. instantiating at least two screens associated with the workspace,

d. instantiating at least one presentation space associated with each of the at least two screens, and

e. presenting a respective at least one data fragment in each respective at least on presentation space,

wherein:

the at least one data fragment is operable to be currently selected when presented in the respective at least one presentation space, and

in response to said selection, at least one other of the at least one presentation space presenting a corresponding datafragment.

The method may further comprise constraining the data fragment presented in at least one presentation space, wherein constraining may include searching, filtering, sorting, or a combination of these. The method may further comprise selecting the at least one presentation space to have focus, and in response to the at least one presentation space having focus, presenting a constrained data fragment in at least one other of the at least one presentation space.

According to yet another aspect of the present disclosure, there is provided a computer program product comprising a computer readable medium storing computer executable instructions thereon that when executed by a computer perform the above-provided method.

### DESCRIPTION

The invention will be more fully illustrated by the following detailed description of non-limiting specific embodiments in conjunction with the accompanying drawing figures. In the figures, similar elements and/or features may have the same reference label. Further, various elements of the same type may be distinguished by following the reference label with a second label that distinguishes among the similar elements. If only the first reference label is identified in a particular passage of the detailed description, then that passage describes any one of the similar elements having the same first reference label irrespective of the second reference label.

### 1. BRIEF DESCRIPTION OF THE DRAWINGS

FIG. 1 is a Unified Modeling Language (UML) 2 deployment diagram of one embodiment of a system for managing data in accordance with aspects of the present invention, the system having nodes that include a Server connected to an Edge Device.

FIG. 2 is a UML 2 component diagram of one embodiment of a node in the system of FIG. 1, the node having a stack of devices and components.

FIG. 3 is a graphical user interface diagram showing one embodiment of an interactive display of an Edge Device of FIG. 1.

FIG. 4 is a UML 2 class diagram of a Client Component deployed on an Edge Device of FIG. 1 to support the graphical user interface of FIG. 3.

### 2. DETAILED DESCRIPTION OF SPECIFIC EMBODIMENTS

### (a) Structure of Specific Embodiments

The structure of the invention will now be illustrated by explanation of specific, non-limiting, exemplary embodiments shown in the drawing figures and described in greater detail herein.

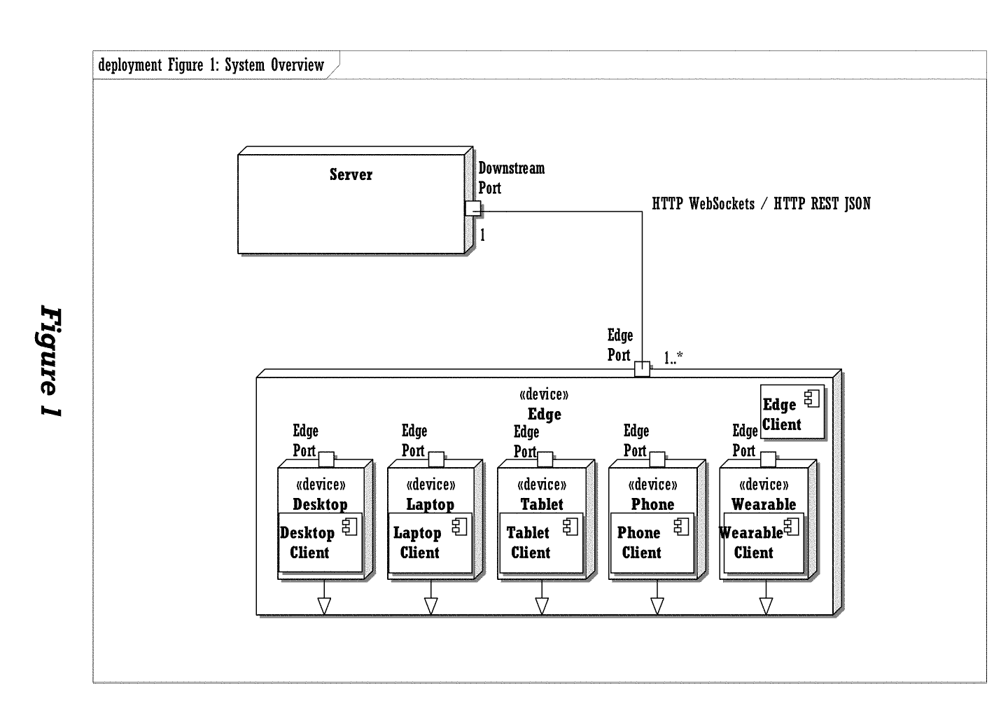

FIG. 1 shows a system for managing data according to one embodiment of aspects of the present disclosure. The system may include one or more Servers connected to serve data to at least one Edge Device. Those skilled in the art will appreciate that the teachings of the present disclosure extend also to embodiments where all data and functionality are local to an Edge Device, shared peer-to-peer on a system of Edge Devices, or shared between one or more Servers and one or more Edge Devices.

The at least one Edge Device might include a plurality of Edge Devices having different computation, presentation and communication characteristics, including for example a Desktop Device, a Laptop Device, a Tablet Device, a Phone Device or a Wearable Device, such Edge Device or plurality of Edge Devices being configured for use by one user or a plurality of users, such users having one activity or a plurality of activities, each activity being characterized by particular interactions with particular data.

Thus, those skilled in the art will recognize that the network topology depicted in FIG. 1 has been simplified for clarity. For example, the network could be scaled to include multiple servers, clients, devices or more generally resources for each node. Furthermore, a particular node might be spread across multiple physical locations (or jurisdictions), which might increase, decrease or change over time, including on-the-fly, depending on resource demands and network management decisions. The network could be provided as a managed network service.

Those skilled in the art will understand that in an internetworked system an action is often the result of coordinated activities occurring at multiple nodes in the system. In the case of a system built on the Internet, these nodes are often distributed ad hoc and unpredictably across multiple jurisdictions. The actions as described or claimed herein are intended to encompass at least: (a) actions performed directly and completely within the jurisdiction of the patent, (b) actions coordinated within the jurisdiction but with at least some activities performed outside the jurisdiction, (c) actions coordinated outside the jurisdiction but with at least some activities performed within the jurisdiction, and (d) actions performed for the benefit of a node within the jurisdiction or a person within the jurisdiction using that node. An example of such coordination would be serving a layout for a web page from one node and serving content for insertion into the layout from one or more other nodes, including through the use of server-side scripting, client-side scripting, and Asynchronous JavaScript and XML (AJAX) techniques.

In general, each node, server, client, device and more generally resource might be a duly configured general purpose programmable computing and communication resource, sometimes called a processing unit or a computing or communication device, for example a server, a workstation, a desktop computer, a laptop computer, a tablet, a smartphone or a wearable device. Alternatively, a device might be a more specific or purpose-built device, for example a smart field-use tool, a point-of-service device, a point-of-sale device, a self-serve kiosk or a smart appliance. Furthermore, each resource might include a farm of computing devices or one or more virtualized computer resources embodied as processes operating on a physical general purpose programmable computing and communication device. Such farmed or virtualized computers might themselves be distributed over their own local or wide area network, not shown.

In essence, nodes, devices, servers, and clients are roles or functions performed in the system by properly configured computing and communication resources. Multiple roles or functions could be performed by one resource and one role or function could be distributed over multiple resources. The specific character and configuration of a resource and its connecting network topology is important to the extent that it supports the performance of the assigned roles or functions.

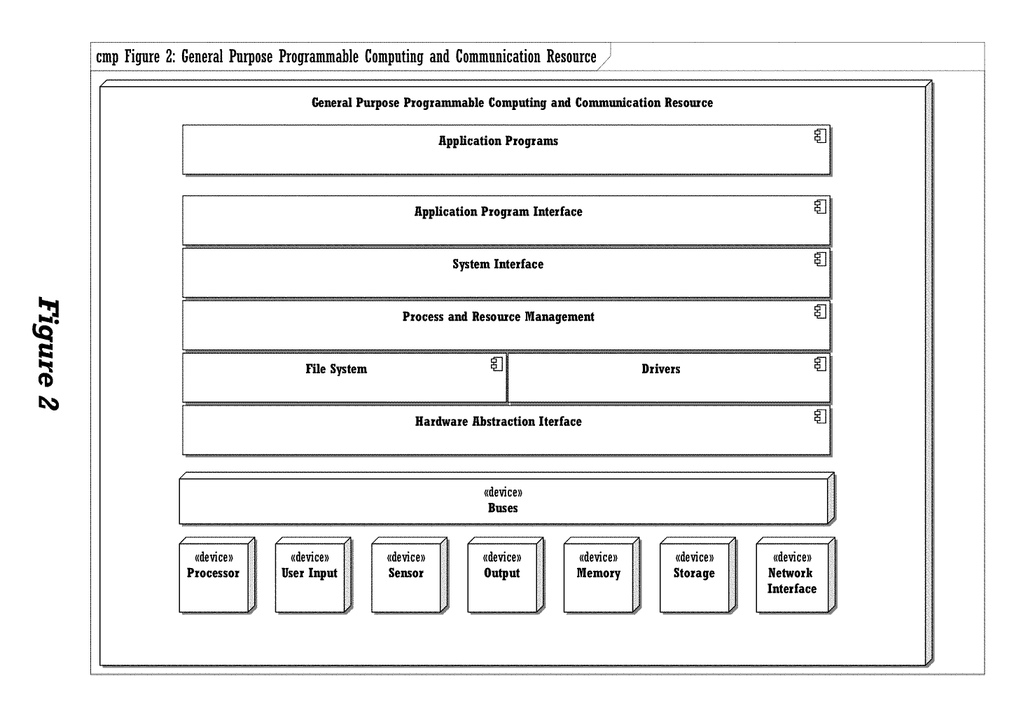

FIG. 2 shows an exemplary architecture for a typical computing and communication resource embodying a node of FIG. 1. These resources have a bottom hardware layer, a middle operating system layer and a top application program layer. Those skilled in the art will recognize the aspects in which like virtualized hardware and resources depart from like physical ones.

The hardware layer provides the resource with computing and communication hardware, including: (a) a Processor to execute processes of instructions and to compute data, (b) user Input hardware to receive input from a user, such as a keyboard (real or virtual), a selection device (for example a mouse, touchpad, touchscreen or other haptic sensor) or a microphone, (c) environmental Sensors to receive input from the environment, such as a camera, a location sensor (e.g. GPS global positioning satellite receiver or cellular radio), an orientation sensor (e.g. compass, gyroscope), a movement sensor (e.g. GPS receiver, accelerometer), or a scanner (e.g. an optical scanner, a magnetic scanner, a chip-and-PIN scanner, a field scanner (e.g. radio frequency identification—RFID, near field communication—NFC), a chemical scanner, or a biometric scanner), (d) Output hardware to provide information to a user, such as a video display, a printer or a speaker, (e) Memory such as read only memory and random access memory to store data and processing instructions, (f) mass Storage such as electromagnetic, optical or nonvolatile solid-state media to store data and processing instructions and (g) a Network Interface to support communication with other devices in accordance with known protocols such as code division multiple access (CDMA), global system for mobile communications (GSM), long term evolution (LTE), IEEE standard 802.11 (Wi-Fi), IEEE standard 802.3 (Ethernet), and transmission control protocol/internet protocol (TCP/IP), all interconnected by Buses such as address and data buses and control lines such as interrupt and clock lines and such other connections and components as is conventionally required and known in the art.

Stored in a portion of the read only Memory and the mass Storage are the components of the operating system layer, for example LINUX® or Microsoft® Windows® Server® or Mac® OS X Server® for a resource such as general purpose programmable computer configured as a server or LINUX® or Microsoft® Windows® or Mac® OS X® for a resource such as a general purpose programmable computer configured as a client or even Microsoft® Windows Phone®, Apple® iOS®, Google® Android®, BlackBerry® QNX® or Symbian®, for a portable such device. The operating system layer provides the basic instructions to direct the Processor how to interact with the other hardware described above and more generally how to perform the functions of a communication and computing resource, including storing, accessing and computing data, and communicating with other devices, providing for example a Hardware Abstraction Interface, a File System, Drivers for devices, Process and Resource Management, a System Interface, and an Application Program Interface. The operating system may be configured or extended to provide a web services framework, such as for distributed computing, such as the Windows Communication Foundation application programming interface in the .NET Framework.

The operating system layer presents the Application Program Interface to the Application Program layer, so the Processor can execute more sophisticated combinations of processes under the direction of higher level Application Programs stored in mass Storage and loaded into random access Memory for execution, for example the Components and other processes that will be elaborated below. The Application Program layer may also include more purpose-specific application programming interfaces.

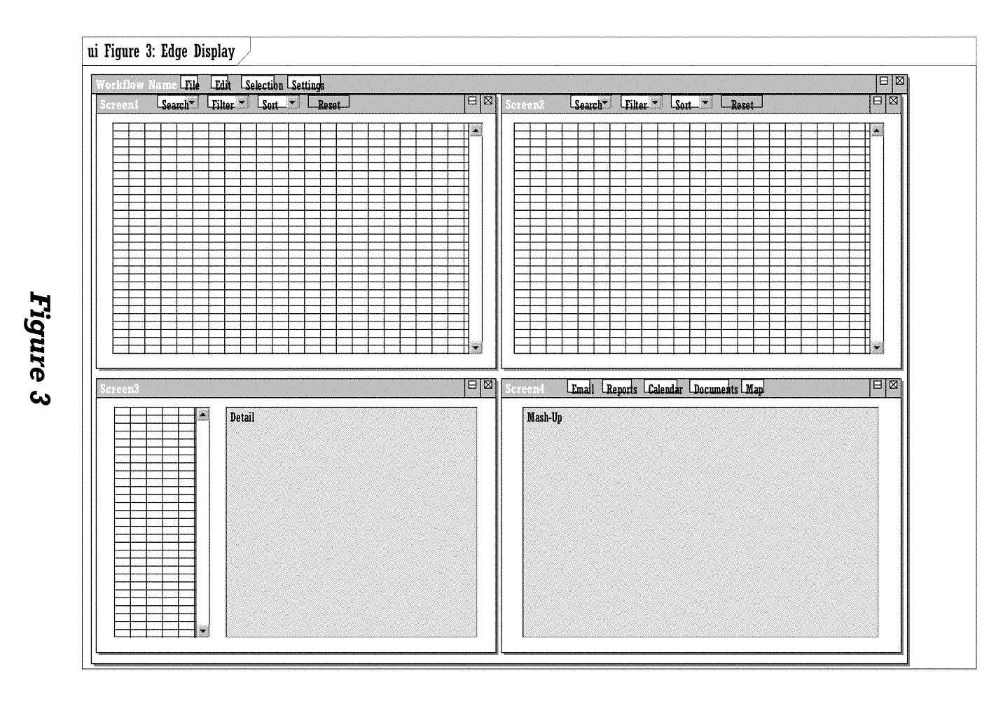

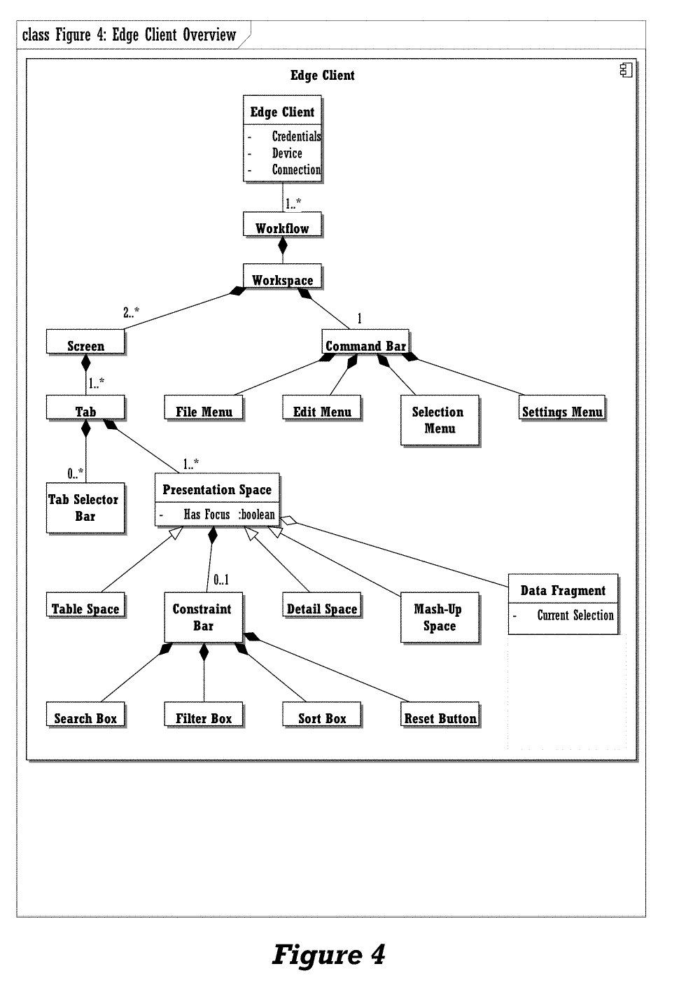

FIGS. 3 and 4 provide further detail about the interactive presentation and manipulation of data at one of the at least one Edge Devices, wherein FIG. 3 illustrates one embodiment of a graphical user interface and FIG. 4 illustrates classes that support that graphical user interface.

An Edge Client deployed on the at least one of the Edge Devices may be provisioned with at least one Workflow commensurate with the Edge Client's Credentials and matched to the characteristics of the at least one of the Edge Devices and its communication Connections, and tailored, as will be described further below, to a user's one activity or plurality of activities, each activity being characterized by the user's particular interactions with particular data. Those skilled in the art will recognize that such provisioning might be conducted in many ways, for example, including with the Server or a server, or without a server, for example with a configuration tool or medium.

The Workflow has a Workspace, having a user-interactive Command Bar and at least one Screen. The Command Bar may include user-interactive objects, such as a File Menu, an Edit Menu, a Selection Menu and a Settings Menu through which a user may interrogate and direct the Workflow, including toggling between Workflows in the case that more than one Workflow has been provisioned. Each Screen may correspond to either a physical display device or a window presented on a physical display, such that multiple Screens may be presented on one or multiple physical display devices.

As illustrated in FIG. 3, four Screens are provided, for example; however those skilled in the art will recognize that depending on the user preferences and the nature of particular data and Workflows, more or fewer screens may be deployed effectively.

Each Screen has at least one Tab having at least one Presentation Space. If a Screen has more than one Tab, a user-interactive Tab Selection Bar may be configured to enable a user to toggle between Tabs. Each Presentation Space may be configured for most effective presentation of an associated Data Fragment. For example, a Data Fragment that includes fields for many records would be well-presented in a Table Space. In contrast, a Data Fragment that includes many fields detailing one record would be well-presented in a Detail Space. In contrast again, a Data Fragment that includes renderable objects linked to (e.g. document files) or associated with (e.g. a map location) one record would be well-presented in a Mash-Up Space. A Presentation Space may also include a user-interactive Constraint Bar, having for example a Search Box, a Filter Box, a Sort Box and a Reset Button, to further constrain the presented Data Fragment for clearer presentation.

Because the data is fragmented into Data Fragments according to a carefully-architected predetermined Workflow, relationships between Data Fragments are well-understood at the time of the architecting and such relationships can be implemented in the user-interactivity of the Screens, such that constraints and selections in each of the Screens can affect the retrieval and presentation of data in the other Screens.

In one example:
a first Screen1 may include Table Space for presenting records about a set of companies, for example sales prospects in a particular territory,
a second Screen2 may include Table Space for presenting records about a set of people,
a third Screen3 may include Table Space for presenting records about a set of notes and a Detail Space for presenting details or content of one of the notes, and
a fourth Screen4 may include Mash-Up Space for presenting Emails, Reports, Calendar entries, Documents and Map locations, and more generally linked to (e.g. documents) or associated (e.g. a map location) renderable objects.

The current presentation of each of these Screens can depend on which data are constrained or currently selected in other Screens and on which Presentation Space currently has focus.

For example, if a user were to select in Screen1 a particular one of the presented company records, then in Screen2, only the records of people associated with that company might be displayed. Similarly, if Screen1 were constrained to present only records of companies having a place of business in Marin County, Calif., then in Screen2, only the records of people associated with those companies might be displayed.

Extending this example, if a user were then to select in Screen2 a record of one such person, then in Screen3, only records of notes associated with that person might be displayed in the Table Space. If in Screen3 a user were to select one such note record, then in the Detail Space details about and/or content of that note record would be presented. Alternatively, if Screen2 were constrained to present only records of people having as a last name Smith, then in Screen3, only the records of notes associated with such a subset of people might be displayed.

Similarly, if a user were to select in Screen2 a record of one such person, then in Screen4, Emails, Reports, Calendar entries, Documents and Map locations associated with that person might be presented and/or rendered in the Mash-Up Space, for example.

Working in the other direction, if a user were to select a note in Screen3 or an Email, Report, Calendar entry, Document and Map location in Screen4, then Screen1 might present only companies associated with that selection and Screen2 might present only people associated with that selection, for example.

Those skilled in the art will recognize that a user might apply successive selections and constraints in various combinations of Screens to build up a sophisticated search, filter and/or sort through graphic refinement.

Depending on Credentials, data might be added, updated or deleted.

Those skilled in the art will recognize that such systems and methods might be embodied using a model-view-controller architecture, passing messages between screens in response to triggering events, for example mouse-clicks or key-presses.

Those skilled in the art will recognize that the invention is not limited to specific types of data, workflows, activities or sectors, for example as illustrated above. The invention might be deployed for example to manage:
personal information on a standalone laptop computer,
a children's sports league in the cloud,
municipal publics works on a client-server network,
prospective investments on a super computer, or
widely distributed climate observations on a peer-to-peer network.

As embodied herein, each Workflow may persist at the Server, and at the Edge Device reside only in Memory, in whole or in part; however, embodiments with Edge Device persistence are also possible, including standalone Edge Device embodiments.

### (b) Operation of Specific Embodiments

With reference now to FIGS. 1-4, the operation of these specific embodiments of the system will now be described.

A process modeler (or system analyst or the like) would identify the tasks performed for various activities in an organization and deconstruct those tasks into Workflows having associated Data Fragments needed by a user executing the task in performance of the activity. Conventionally, data is presented to such a user by one or more Saas Cloud Servers as a succession of hyperlinked pages that must be laboriously drilled through to locate sought data. Instead, herein the modeler would create concurrent Screens for each Workflow, such Screens having selectable and constrainable Presentation Spaces for presenting the associated Data Fragments.

This Workflow data fragmentation allows for more efficient queries, providing better prediction of what Data Fragments need to be served in a priority order to efficiently meet the needs of the user. Thus for example, where a Screen1 Data Fragment has a higher rank in a parent-child hierarchy (e.g. company data) than does a Screen2 Data Fragment (e.g. employee data)—in the respect that a user is likely to work through a task from company data toward employee data—then it would make sense that the Screen1 Data Fragment be provided first and then while the user is considering that data the Screen2 Data Fragment be provided. The default prioritization created by the process modeler may be refined in real-time by the selection and constraint choices of the user of the Edge Client, to focus on providing the data of highest interest to the user. Thus for example, if a user has selected in Screen1 ABC Company Ltd. as the target of his interest, then the providing of Screen2 would be refined to prioritize first those people associated with ABC Company Ltd.

Those skilled in the art will recognize that the present disclosure provides advantages even in embodiments where the Server is not present or is otherwise not needed or at least continuously needed, in which the data required by an Edge Client resides on the corresponding Edge Device, having been previously downloaded or otherwise provisioned, or wherein the Edge Device functions as a mini-server for the Edge Client.

### (c) Description Summary

Thus, it will be seen from the foregoing embodiments and examples that there has been described a way for accessing, updating, and more generally managing, enterprise data.

While specific embodiments of the invention have been described and illustrated, such embodiments should be considered illustrative of the invention only and not as limiting the invention. In particular, all quantities described have been determined empirically and those skilled in the art might well expect a wide range of values surrounding those described to provide similarly beneficial results.

It will be understood by those skilled in the art that various changes, modifications and substitutions can be made to the foregoing embodiments without departing from the principle and scope of the invention expressed in the claims made herein.

1. An electronic device, comprising:
a. a processor,
b. a storage medium, and
c. a client component stored on the storage medium, the client component comprising machine-executable code executable by the processor to manage data, wherein managing data comprises:
i. instantiating a workflow,
ii. instantiating a workspace associated with the workflow,
iii. instantiating at least two screens associated with the workspace,
iv. instantiating at least one presentation space associated with each of the at least two screens, and
v. presenting a respective at least one data fragment in each respective at least one presentation space,
wherein:
the at least one data fragment is operable to be currently selected when presented in the respective at least one presentation space, and
in response to selection of the at least one data fragment, at least one other of the at least one presentation space presents a corresponding data fragment.

2. The electronic device as claimed in claim 1, wherein the at least one presentation space has a constraint bar, having at least one of:
i. a search box,
ii. a filter box, and
iii. a sort box,
configured to constrain the data fragments presented, respectively by search, filter and sort.

3. The electronic device as claimed in claim 2, wherein:
the at least one presentation space is operable to have focus, and
in response to the at least one presentation space having focus, at least one other of the at least one presentation space presents a constrained data fragment constrained by the constraint bar of the at least one presentation space.

4. The electronic device as claimed in claim 3, wherein the at least one presentation space has at least one of:
i. a table space,
ii. a detail space, and
iii. a mash-up space.

5. The electronic device as claimed in claim 4, wherein the at least two screens respectively have tabs for selecting between presentation spaces.

6. The electronic device as claimed in claim 1, wherein the at least one presentation space has at least one of:
i. a table space,
ii. a detail space, and
iii. a mash-up space.

7. The electronic device as claimed in claim 6, wherein the at least two screens respectively have tabs for selecting between presentation spaces.

8. A computer-implemented method for managing data, comprising:
a. instantiating a workflow,
b. instantiating a workspace associated with the workflow,
c. instantiating at least two screens associated with the workspace,
d. instantiating at least on presentation space associated with each of the at least two screens, and
e. presenting a respective at least one data fragment in each respective at least one presentation space,
wherein:
the at least one data fragment is operable to be currently selected when presented in the respective at least one presentation space, and
in response to said selection, at least one other of the at least one presentation space presents a corresponding data fragment.

9. The computer-implemented method as claimed in claim 8, further comprising constraining the data fragment presented in at least one presentation space.

10. The computer-implemented method as claimed in claim 9, wherein constraining includes at least one of:
a. searching,
b. filtering, and
c. sorting.

11. The computer-implemented method as claimed in claim 9, further comprising:
a. selecting the at least one presentation space to have focus, and
b. in response to the at least one presentation space having focus,
presenting a constrained data fragment in at least one other of the at least one presentation space.

12. A computer program product comprising a computer readable medium storing computer executable instructions thereon that when executed by a computer perform the method steps of claim 8.
